(19) United States
(12) Patent Application Publication
(10) Pub. No.: US 2011/0225883 A1
(43) Pub. Date: Sep. 22, 2011

(54) VEGETATION WALL

(75) Inventor: Kenneth John Clifford, Paw Paw, MI (US)

(73) Assignee: CLIFFORDS PERENNIAL AND VINE INC, Paw Paw, MI (US)

(21) Appl. No.: 13/048,406

(22) Filed: Mar. 15, 2011

Related U.S. Application Data
(60) Provisional application No. 61/314,411, filed on Mar. 16, 2010.

(51) Int. Cl. A01G 9/02; A01G 25/00

(52) U.S. Cl. 47/82; 47/83

(57) ABSTRACT

A vegetation wall for supporting vegetation and including at least one panel made from a porous filter media formed of a plurality of strands arranged to form an open, three-dimensional structure with interstitial spaces that provide both air and water permeability. The filter media can filter water, such as by removing nitrogen gas from the water, promoting the colonization of beneficial bacteria that aide in nitrification of the water, and balancing the pH of the water. The vegetation wall can be a free-standing wall, or attached to the side or roof of a building.

### CROSS-REFERENCE TO RELATED APPLICATION

This application claims the benefit of U.S. Provisional Application No. 61/314,411, filed Mar. 16, 2010, which is incorporated herein by reference in its entirety.

### BACKGROUND

Vegetation walls support vegetation on an inclined or vertical surface, such as a roof or exterior wall of a building. These types of walls, also known as green walls or green roofs, living walls, biowalls, and vertical gardens, are partially or completely covered with vegetation and a growing medium. Vegetation walls can also include draining and irrigation systems.

Vegetation walls on the exterior of buildings can reduce energy consumption by reducing the overall temperature of the building, while vegetation walls inside a building can improve indoor air quality; in either installation, vegetation walls can provide sound-dampening. Another major benefit of vegetation walls is the reduction of water runoff. In some cities, green roofs are becoming mandatory for new or existing construction. Other cities offer financial incentives to install green roofs on buildings.

### BRIEF SUMMARY

The invention generally relates to a vegetation wall for supporting vegetation, which includes a frame defining an area configured to receive a media for growing vegetation, and at least one panel provided on the frame and comprising a porous filter media formed of a plurality of strands arranged to form an open, three-dimensional structure with interstitial spaces that provide both air and water permeability.

### BRIEF DESCRIPTION OF THE DRAWINGS

In the drawings:

FIG. 1 is a perspective view of a vegetation wall in accordance with one embodiment of the present invention.

FIG. 2 is an exploded view of the vegetation wall of FIG. 1.

FIG. 3 is a perspective view of the vegetation wall of FIG. 1 with a portion cut-away to show the interior of the vegetation wall.

FIG. 4 is a vertical cross-section through a portion of the vegetation wall of FIG. 1.

FIG. 5 is a rear view of the vegetation wall, with a rear panel removed to illustrate an irrigation system for the vegetation wall of FIG. 1.

FIG. 6 is a perspective view of a vegetation wall in accordance with a second embodiment of the invention.

FIG. 7 is a perspective view of a vegetation wall in accordance with a third embodiment of the invention.

### DESCRIPTION OF AN EMBODIMENT OF THE INVENTION

FIG. 1 is a perspective view of a vegetation wall 10 in accordance with one embodiment of the present invention. The vegetation wall 10 supports vegetation 12 in a growing media (not shown) and can be orientated vertically or at an incline with respect to a ground surface. The vegetation wall 10 can further be free-standing, or be positioned on or form a wall or roof of a building. More than one vegetation wall 10 can be fixed together to form a wall structure having a desired height and length and can give the appearance of a single wall. The vegetation wall 10 can be assembled at a first assembly site, and then transported to a second installation site once the vegetation 12 has matured.

The vegetation wall 10 has a front surface 14 and a rear surface 16 joined by a peripheral edge surface 18. As illustrated, the vegetation wall 10 has a quadrilateral shape, such as a square or rectangle, although other wall shapes are possible. Further, while vegetation 12 is only shown on the front surface 14, vegetation may also be supported on the rear surface 16, the peripheral edge surface 18, or on any combination of surfaces.

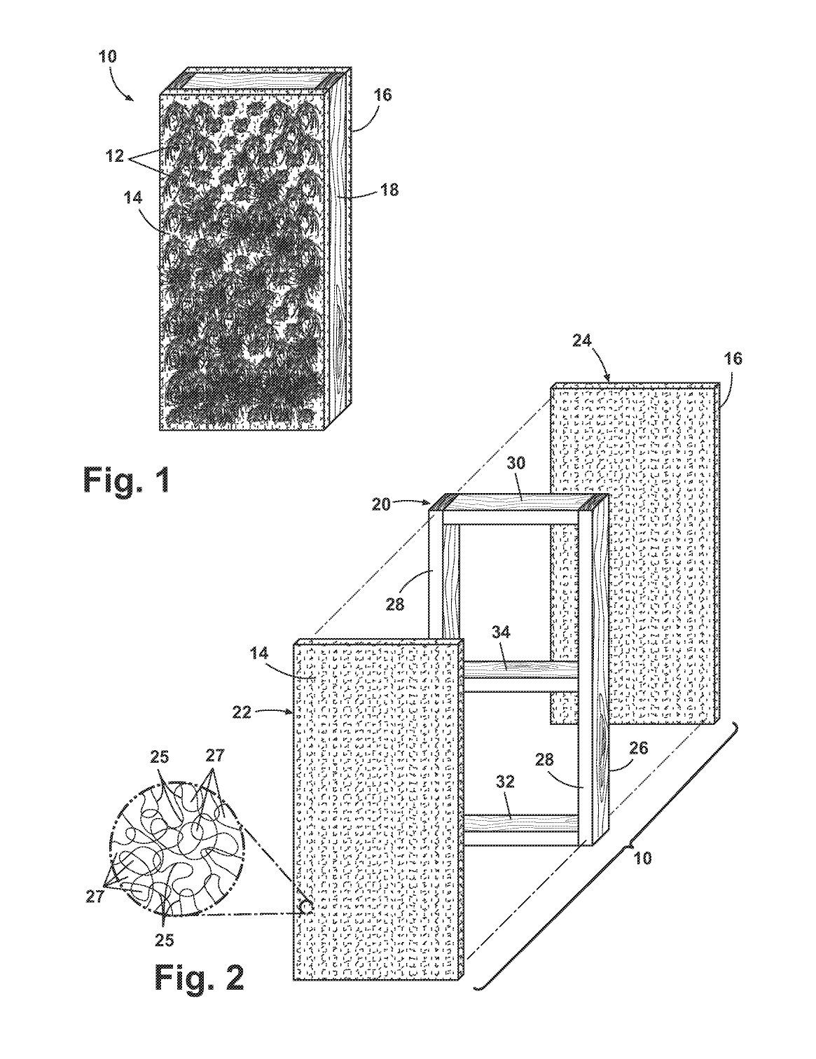

FIG. 2 is an exploded view of the vegetation wall 10 of FIG. 1. The vegetation wall 10 comprises a frame 20, a first front panel 22 defining the front surface 14, and a second rear panel 24 defining the rear surface 16. The frame 20 includes an outer border 26 comprising two opposing side members 28 joined by a top member 30 and a bottom member 32. One or more support members 34 extends between the opposing side members 28 and provides rigidity to the frame 20 and helps support weight of the vegetation 12. The frame 20 can be made from wood, metal, or any other sufficiently rigid material. In one example, the frame 20 can be made from 2×4 treated wood. The panels 22, 24 can be secured to the frame 20 using a suitable fastening means, including, but not limited to, mechanical fasteners such as screws or nails, or a bonding agent, such as an adhesive.

The panels 22, 24 can be made from a porous or lattice-like material having an open, three-dimensional structure. The porous material can be selected to be weather-resistant for outdoor applications. In one embodiment, the porous material can include a plurality of individual strands 25 wound, looped, twisted, layered or otherwise connected or formed together to create a matrix having pores and/or interstitial spaces 27 between the strands 25. The pattern 25 of the strands in the matrix can be irregular to create irregular paths for air flow through the panels 22, 24. In one embodiment, the strands 25 can be made from a thermoplastic polymer, such as a polypropylene or thermo-polypropylene compound, or polyethylene.

The material for the panels 22, 24, can be selected to be permeable to at least air so that air can pass through the panels 22, 24. The material can also be selected to be permeable to water so that water can pass through the panels 22, 24. The material can also be selected to promote the colonization of beneficial bacteria on the panels 22, 24. Permeability and bacteria-colonization are affected at least in part by the size and number of interstitial spaces 27. The material properties of the panels 22, 24 can be selected to provide panels 22, 24 with a desired size and number of the interstitial spaces 27 that will allow air and/or water to permeate the panels 22, 24, but will also retain the growing media for the vegetation 12 in place and substantially prevent the growing media from leaching through the panels 22, 23, and will also encourage the colonization of beneficial bacteria. Such material properties can include the average diameter of the strands 25, porosity (or free volume), and specific surface area.

The specific surface area of the panels 22, 24 can be equal to or greater than 100 m²/m³. More specifically, the specific surface area of the panels 22, 24 can be 150-760 m²/m³, 150-200 m²/m³, 250-300 m²/m³, 350-400 m²/m³, or 450-500 m²/m³. Still more specifically, the specific surface area of the panels 22, 24 can be equal to or greater than 150 m²/m³, equal to or greater than 190 m²/m³, equal to or greater than 290 m²/m³, equal to or greater than 365 m²/m³, equal to or greater than 460 m²/m³, or equal to or greater than 760 m²/m³.

A higher specific surface area in the range of 365-460 m²/m³ has been found to be best for filtering debris from heavy or torrential rain. Torrential rain can dislodge and remove portions of a growing media within the vegetation wall 10. For example, chips of composted tree bark used in the growing media can be dislodged during rain. A specific surface area of 365-460 m²/m³ is sufficient to filter and contain portions of the growing media, and prevent these portions from clogging drainage paths from the vegetation wall 10.

The average strand diameter (i.e. the average diameter of the strands 25) can be equal to or less than 2 mm. More specifically, the average diameter of the strands 25 can be equal to or less than 1.9 mm, equal to or less than 1.7 mm, equal to or less than 0.9 mm, equal to or less than 0.55 mm, equal to or less than 0.45 mm, or equal to or less than 0.3 mm.

The porosity (or free volume) of the panels 22, 24 can be equal to or greater than 90%. More specifically, the porosity of the panels 22, 24 can be equal to or greater than 92%, equal to or greater than 93%, or equal to or greater than 94%.

In one embodiment, the panels 22, 24 can have the following combination of material properties: a specific surface area of approximately 460 m²/m³, an average strand diameter of approximately 0.5 mm, and a free void space equal to or greater than 94%.

One example of a suitable porous material for the panels 22, 24 with one or more to the above features is sold under the trade name Matala® and distributed in the United States by Matala USA.

In order to simplify construction, both panels 22, 24 can be formed from the same material. Alternately, different materials can be used for the front and rear panels 22, 24, depending on whether vegetation will be grown from one or both surfaces 14, 16 of the vegetation wall. As illustrated, vegetation 12 is grown from the front surface 14, and therefore, at least the front panel 22 can be formed from the porous material discussed above.

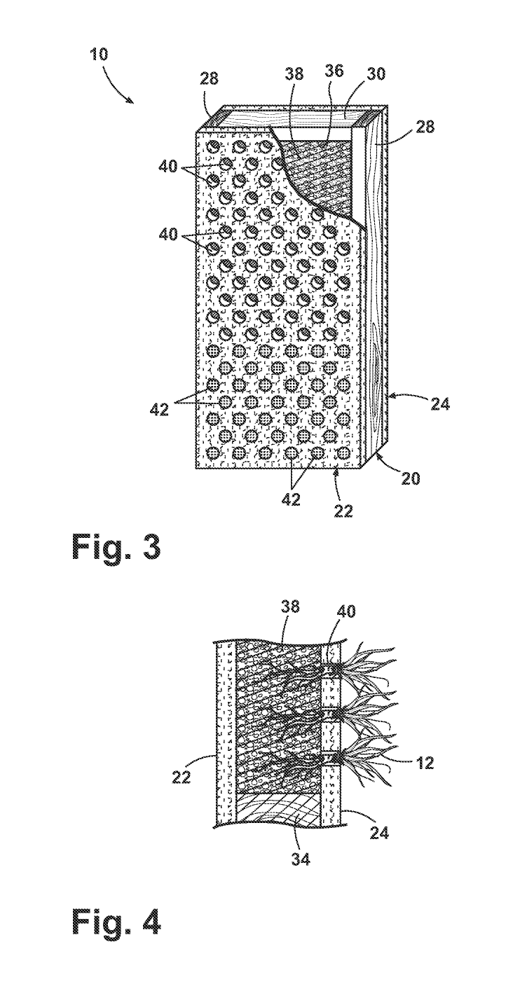

FIG. 3 is a perspective view of the vegetation wall 10 with a portion cut-away to show the interior of the vegetation wall 10 and FIG. 4 is a partial cross-sectional view of the vegetation wall 10. When the panels 22, 24 are assembled to the frame 20, at least one interior cavity 36 is formed. This cavity 36 can be filled with a growing media 38 capable of supporting vegetation. Examples of growing media 38 include soil, peat moss, coconut fiber, perlite, vermiculite, wood residues, soiless mixes, synthetic fibrous materials, or mixtures thereof. The growing media 38 can substantially fill each portion of the cavity 36. As mentioned above, the pores of the panels 22, 24 can be configured and sized to prevent the growing media from substantially passing through the panels.

One or more planting holes 40 can be formed in at least one of the panels 22, 24 to expose the growing media 38. The holes 40 can be formed prior to or after the assembly of the panels 22, 24 with the frame 20. Vegetation, seeds or roots can be planted in the exposed growing media 38 via the holes 40. The holes 40 can be sized to permit vegetation to grow outwardly through the holes 40. Thereafter, the holes 40 may be filled with a plug 42 to prevent the growing media 38 from draining out of the cavity 36 through the holes 40. Examples of plug materials include organic materials like bare root or cuttings, although inorganic materials can be used as well. Alternatively to forming holes, the panels 22, 24 may be porous, and the pores may be of a size sufficiently large to allow vegetation to be planted in the growing media 38 via the pores.

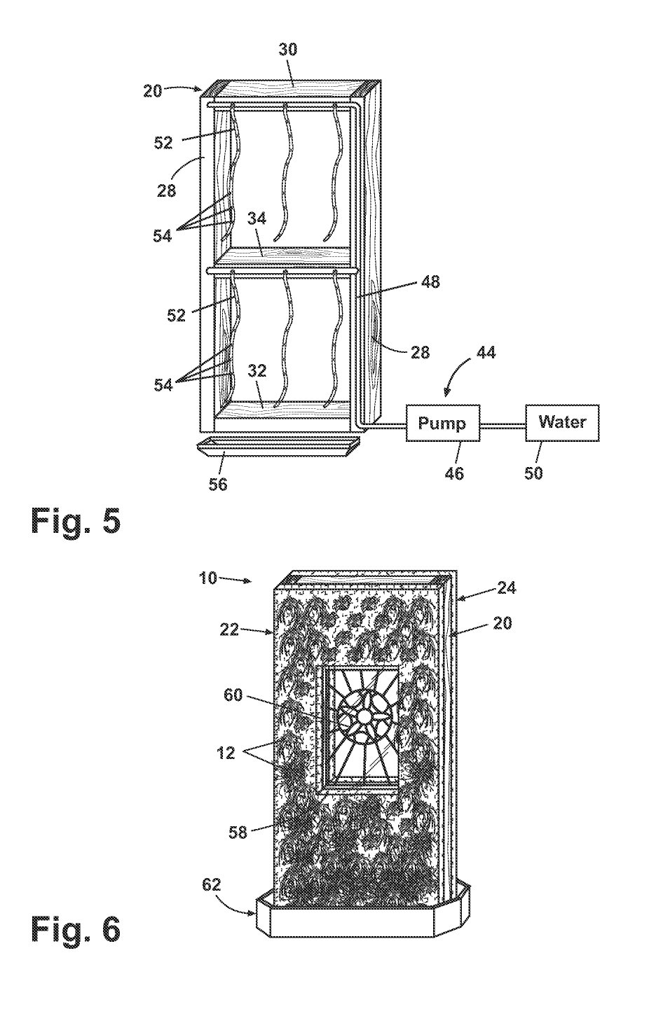

Referring to FIG. 5, the vegetation wall 10 can further comprise an irrigation system 44 for supplying water or other nutrients to the vegetation growing in the growing media 38. The irrigation system 44 can be a “drip” system, whereby water drips into the cavity and trickles down through the growing media 38 and vegetation to the bottom of the cavity. As illustrated, the irrigation system 44 includes a pump 46 supplying water to one or more pipes 48 from a source of water 50. The pipe 48 includes one or more flexible tubes 52 extending from and in fluid communication with the pipe 48. Each tube 52 is wound through the growing media 38 and has multiple perforations 54 forming exits for the water. A suitable water collector 56 can be provided for collecting any run-off water. The water collector 56 can be coupled to a drainage (not shown) to transport the water away from the vegetation wall 10 or can be coupled to the pump 46 to recirculate the run-off water back through the irrigation system 44. At least the pipe 48 can be coupled to the frame 20, although the pump 46 and source of water 50 can also be coupled to the frame 20.

FIG. 6 is a perspective view of the vegetation wall 10 in accordance with a second embodiment of the invention. In this embodiment, the vegetation wall 10 includes one or more openings 58 formed in vegetation wall 10 for receiving a fixture 60. As illustrated, one fixture 60 is mounted to the vegetation wall 10 within the opening 58. As such, the opening 58 extends through the frame 20 and panels 22, 24. The fixture 60 can be ornamental, functional, or a combination of both. Examples of fixtures 60 include stained glass, latticework, and lighting.

Also in this embodiment, a base 62 for the vegetation wall 10 is provided. As illustrated, the base 62 includes a wall-like structure around a lower portion of the vegetation wall 10. The base 62 can be ornamental, functional, or a combination of both. A functional base 62 can support and/or provide stability to a free-standing vegetation wall, or can be used to secure the vegetation wall 10 to another structure. A functional base 62 may also house a portion of the irrigation system, such as the pump 46, the source of water 50, and the water collector 56. The base 62 may be used if the vegetation wall is free-standing or if it forms an exterior wall, and is not used when the vegetation wall 10 is installed on a roof.

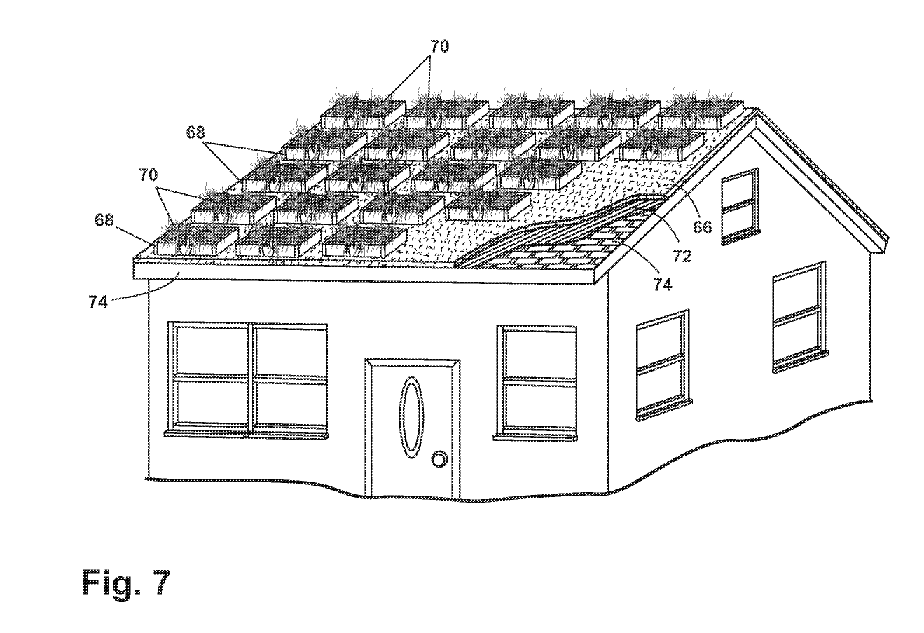

FIG. 7 is a perspective view of the vegetation wall 10 in accordance with a third embodiment of the invention. In this embodiment, the vegetation wall 10 is installed on a roof 64, which may therefore, collectively be considered to be a green roof. The vegetative wall 10 comprises a single layer of one or more panel(s) 66 and a frame in the form of one or more tray(s) 68 containing a growing media (not shown) and vegetation 70. An optional waterproofing membrane 72 can be inserted between the panel 66 and the roof 64. Alternately, the panel 66 can be in direct contact with the roof 64. Edging 74 can be applied to the roof 66 to prevent the vegetation wall 10 from shifting or sliding on the roof 66. A suitable irrigation system (not shown) can also be provided.

The panel(s) 66 can be configured to not substantially compress under the weight of the trays 68, which will leave the majority of the interstitial spaces 27 (see FIG. 2) open, allowing air and water to flow between the trays and the roof 64. The interstitial spaces 27 can protect the waterproofing membrane 72 due to the increased air flow under the trays 68.

The vegetation wall 10, whether installed as a green wall or a green roof, offers several advantages over prior vegetation walls. These advantages are related to water runoff, green roof installations, and construction.

The vegetation wall 10 can receive water through rainfall or by the irrigation system 44. In either case, there may be water runoff from the vegetation wall 10, which is the water flow which occurs when the growing media 38 is infiltrated to full capacity. In other words, water runoff is the excess water that flows out of the vegetation wall 10 when the growing media is saturated. The water applied to the vegetation wall 10 can contain environmental contaminants. For example, in the case of rainfall, the rain can be “acid rain”, which is unusually acidic and has a harmful effect on plants and animals. In another example, the irrigation system 44 can use well water, which is typically supersaturated with nitrogen gas. In another example, water in municipal distribution systems goes through a purification process that can result in the presence of ammonia (NH₃) in the water. The water runoff can also pick up additional contaminants, such as pesticides or fertilizers applied to the vegetation wall 10 or pollutants on the building wall or roof. The water runoff eventually joins other water sources, such as streams, lakes, runoff drains, or wells, which can lead to water quality problems for surface water and groundwater. For example, water supersaturated with nitrogen can result in gas bubble disease for salmon, trout, carp, and many other species of marine life, the symptoms of which include tissue damage and death. In another example, ammonia (NH₃) is detrimental to marine life and can result in ammonia toxicity in fish.

The vegetation wall 10 provides several advantages over prior vegetation walls related to water run-off. The vegetation wall 10 can act to retain and filter water applied to the vegetation wall 10, thereby reducing the amount of contaminants or pollutants transported to the environment by water runoff. Specifically, as water passes through the vegetation wall 10, the panels 22, 24, 66 can do one or more of the following: (1) remove nitrogen gas (N) from water and adds oxygen (O₂) to the water; (2) aid in the nitrification process; and (3) help to maintain a healthy pH for marine and plant life.

With respect to (1), the panels 22, 24, 66 can aid in degassing water of nitrogen. The interstitial spaces 27 in the panels 22, 24, 66 allow for water flow along the strands 25. The contact time with the strands 25 allows for the release of nitrogen gas (N) from the water back into the air, and increases the oxygen (O₂) in the water. The resulting water runoff is, therefore, better for the environment by being more habitable for marine life.

With respect to (2), the panels 22, 24, 66 aid in the nitrification process by promoting the colonization of beneficial bacteria. This may be done through the selection of the material for the strands 25, or by designing the size of the interstitial spaces 27. For example, strands 25 made from a thermoplastic polymer, such as a polypropylene or thermo-polypropylene compound, or polyethylene can air in nitrification. The size of the interstitial spaces 27 is a function of the average diameter of the strands 25 and the porosity of the panels 22, 24, examples of which are given above. Nitrification is the biological oxidation of ammonia (NH₃) into nitrite (NO₂) followed by the oxidation of the nitrite into nitrate (NO₃⁻). Nitrate is less harmful to marine life than ammonia or nitrite. The panels 22, 24, 66 aid in the nitrification process by allowing beneficial ammonia-oxidizing bacteria, such as Nitrosonomas and Nitrobacter, to colonize the strands 25. Nitrosonomas oxidize ammonia (NH₃) into nitrite (NO₂⁻) as a metabolic process, while Nitrobacter oxidize nitrite (NO₂) into nitrate (NO₃). Ammonia-oxidizing bacteria thus require the presence of oxygen (O₂) to live and grow. The required oxygen (O₂) can be provided by the air flow through the interstitial spaces 27. Additionally, in green roof installations, the moist environment under the trays 68 helps beneficial ammonia-oxidizing bacteria to colonize. The nitrification process can also aid in the reduction or depletion of chloramines (NH₂Cl), which is commonly used as a disinfectant in municipal water distribution systems and is toxic to marine life.

The size of the interstitial spaces 27, which is a function of the average diameter of the strands 25 and the porosity of the panels 22, 24, examples of which are given above, has been found to make the panels 22, 24, 66 resistant to plugging. Debris may, therefore, collect on the upper surface of the panels 22, 24, 66, which can thereafter be easily cleaned off, such as by rinsing the debris with a hose.

With respect to (3), the panels 22, 24, 66 can help maintain the water runoff at a healthy pH for marine and plant life. After a rainy period the panels 22, 24, 66 can be easily cleaned, such as by rinsing off the debris. This allows the use of an all-organic growing media 38. One example of an all-organic growing media 38 is composted pine bark, which has an adjustable pH, simply be composting pine bark until the pH has reached a desired value. A neutral or close-to-neutral pH (for example, around 6-7.5) is desired for a growing media because it will react with acid rain and results in water runoff with a buffered pH that is more suitable for plant and animal life. The use of an all-organic growing media 38 is additional beneficial because the vegetation will require less fertilizing.

The panels 22, 24, 66 also provide several advantages over prior vegetation walls related to green roof installations. Many other materials have been used as a substrate for green roofs, including organic materials, sand/gravel mixes, and heat-expansion materials. Organic materials are subject to erosion with heavy rainfall, which result in plugging rooftop drains. Sand/gravel mixes are less subject to erosion because of the heavy weight of the mix. Many roofs, however, cannot support such heavy weights, especially when saturated with water. Heat-expansion materials are produced by heating minerals and compounds until they expanded, resulting in only a slightly less heavy material than the sand/grave mix. These heat-expansion materials, especially expanded slate and shale, are less capable of supporting plant life, and in heavy rainfall, they tend to roll into rooftop drains, potentially plugging the drains. With the matrix of strands 25 having interstitial spaces 27, the panels 22, 24, 66 are light-weight and do not include any loose material that could plug a rooftop drain. Furthermore, the interstitial spaces 27 allow water and small debris to travel through the panels 22, 24, 66, and into rooftop drains.

The vegetation wall 10 also provides several advantages over prior vegetation walls during construction. The vegetation wall 10 is easy to construct since it includes fewer layers than previous vegetation walls. The panels 22, 24 made of matrix of strands 25 having interstitial spaces 27 also have advantages when it comes to constructing the vegetation wall 10. For their size, the panels will be light weight due to the interstitial spaces 27. The panels 22, 24 can be easily cut with simple tools, such as scissors, and bends easily to accommodate different designs.

While the invention has been specifically described in connection with certain specific embodiments thereof, it is to be understood that this is by way of illustration and not of limitation. Reasonable variation and modification are possible within the scope of the forgoing disclosure and drawings without departing from the spirit of the invention which is defined in the appended claims.

What is claimed is:

1. A vegetation wall for supporting vegetation, comprising:
a frame defining an area configured to receive a media for growing vegetation; and
at least one panel provided on the frame comprising a porous water filter media formed of a plurality of strands arranged to form an open, three-dimensional structure with interstitial spaces that provide both air and water permeability.

2. The vegetation wall of claim 1, wherein the specific surface area is equal to or greater than 100 m²/m³.

3. The vegetation wall of claim 2, wherein the filter media has a specific surface area of 150-760 m²/m³.

4. The vegetation wall of claim 3, wherein the plurality of strands comprise one of a polypropylene compound, a thermo-polypropylene compound, and polyethylene.

5. The vegetation wall of claim 4, wherein the average strand diameter is less than or equal to 2 mm.

6. The vegetation wall of claim 5, wherein the average strand diameter is less than 0.5 mm.

7. The vegetation wall of claim 1, wherein the filter media has a porosity of at least 90%.

8. The vegetation wall of claim 7, wherein the filter media has a porosity of at least 94%.

9. The vegetation wall of claim 1, wherein the filter media has a specific surface area of greater than 450 m2/m3, an average strand diameter of about 0.5 mm or less, and a porosity of greater than or equal to 94%.

10. The vegetation wall of claim 1, wherein the at least one panel comprises a first panel and a second panel provided on opposing sides of the frame and spaced from each other, wherein the area for the growing media is between the first and second panels.

11. The vegetation wall of claim 1, wherein the at least one panel comprises at least one planting hole for exposing the area for the growing media.

12. The vegetation wall of claim 11, further comprising at least one plug for filling the at least one planting hole.

13. The vegetation wall of claim 1, further comprising an irrigation system for supplying water to the area for the growing media.

14. The vegetation wall of claim 1, wherein at least one of the frame and the at least one panel comprises an opening for receiving a fixture.

15. The vegetation wall of claim 14, wherein the fixture comprises at least one of stained glass, latticework, and lighting.

16. The vegetation wall of claim 1, further comprising a base for supporting the vegetation wall in a free-standing position.

17. The vegetation wall of claim 1, further comprising a tray forming the frame.

18. The vegetation wall of claim 1, wherein the average strand size and porosity are selected to provide an environment suitable for the growth of ammonia-oxidizing bacteria.
